(19) United States
(12) Patent Application Publication
(10) Pub. No.: US 2010/0120944 A1
(43) Pub. Date: May 13, 2010

(54) USE OF CURABLE LIQUID ELASTOMERS TO PRODUCE GELS FOR TREATING A WELLBORE

(75) Inventor: David Antony Ballard, Scotland (GB)

Correspondence Address: OSHA LIANG/MI, TWO HOUSTON CENTER, 909 FANNIN STREET, SUITE 3500, HOUSTON, TX, 77010, US

(73) Assignee: M-I L.L.C., Houston, TX (US)

(21) Appl. No.: 12/597,542

(22) PCT Filed: Apr. 23, 2008
(86) PCT No.: PCT/US08/61300

§ 371 Date: Oct. 26, 2009

Related U.S. Application Data
(60) Provisional application No. 60/914,604, filed on Apr. 27, 2007.
(60) Provisional application No. 61/033,133, filed on Mar. 3, 2008.

(51) Int. Cl. C09K 8/12

(52) U.S. Cl. 523/130

(57) ABSTRACT

A method of treating an earth formation that includes introducing at least one curable liquid elastomer composition in a liquid phase into the earthen formation; introducing at least one curing agent into the earthen formation; and contacting the curable elastomer composition and curing agent to form a non-aqueous gel is disclosed.

### BACKGROUND OF INVENTION

1. Field of the Invention

Embodiments disclosed herein relate generally to elastomer compositions used in downhole applications.

2. Background Art

It is well known in the petroleum industry that some hydrocarbon-bearing formations are weakly consolidated or, in fact, may be unconsolidated formations. While such formations are known to contain substantial quantities of oil and gas, the production of oil and gas from these formations is difficult because of the movement of particulates such as sand particles and other finely divided particulate solids from the unconsolidated or weakly consolidated formation into the wellbore. This movement is a result of the movement of fluids and may be a result of the differential pressure between the formation and the wellbore created by pumping or by the production of fluids upwardly through the wellbore.

Some formations are weakly consolidated or unconsolidated initially and others become weakly consolidated as a result of the production of fluids from the formation, especially when water is present in the produced fluid. Formations of this type are formations which are, at least in part, consolidated by the presence of clays in the formation. Such clays can become dispersed and expanded by the production of aqueous fluids from the formation, thereby weakening the overall formation to the point where it becomes unconsolidated or weakly consolidated with the resulting production of particulates into the wellbore. As a result, uncemented, weakly consolidated or unconsolidated formations impose limits on the draw-down pressure which can be used to produce fluids from the formation. This limits the rate at which fluids can be produced from the subterranean formation.

Further, during drilling of such wells, lost circulation of the drilling fluid is a recurring drilling problem, characterized by loss of drilling mud into downhole formations that are fractured, highly permeable, porous, cavernous, or vugular. These earth formations can include shale, sands, gravel, shell beds, reef deposits, limestone, dolomite, and chalk, among others. Other problems encountered while drilling and producing oil and gas include stuck pipe, hole collapse, loss of well control, and loss of or decreased production. Induced mud losses may also occur when the mud weight, required for well control and to maintain a stable wellbore, exceeds the fracture resistance of the formations. A particularly challenging situation arises in depleted reservoirs, in which the drop in pore pressure weakens hydrocarbon-bearing rocks, but neighboring or inter-bedded low permeability rocks, such as shales, maintain their pore pressure. This can make the drilling of certain depleted zones impossible because the mud weight required to support the shale exceeds the fracture resistance of the sands and silts.

In attempting to cure these and other problems, crosslinkable or absorbing polymers, loss control material (LCM) pills, and cement squeezes have been employed. Gels, in particular, have found utility in preventing mud loss, stabilizing and strengthening the wellbore, zone isolation, and water shutoff treatments.

For example, with respect to zonal isolation, situations may arise during which isolation of certain zones within a formation may be beneficial. Specifically, one method to increase the production of a well is to perforate the well in a number of different locations, either in the same hydrocarbon bearing zone or in different hydrocarbon bearing zones, and thereby increase the flow of hydrocarbons into the well. The problem associated with producing from a well in this manner relates to the control of the flow of fluids from the well and to the management of the reservoir. For example, in a well producing from a number of separate zones (or from laterals in a multilateral well) in which one zone has a higher pressure than another zone, the higher pressure zone may disembogue into the lower pressure zone rather than to the surface. Similarly, in a horizontal well that extends through a single zone, perforations near the “heel” of the well, i.e., nearer the surface, may begin to produce water before those perforations near the “toe” of the well. The production of water near the heel reduces the overall production from the well. Thus, it may be advantageous to also use a cement or gel to isolate one zone from another in managing a hydrocarbon reservoir.

Further, with respect to water shut-off treatments, some wells generate much One of the primary techniques used to restrict water from entering the well bore includes the injection of gels into the formation that shut off water-bearing channels or fractures within the formation, and prevent water from making its way to the well.

In many wells, water-based and oil-based muds are both used. Water-based muds are generally used early in the drilling process, whereas oil-based muds are often substituted as the well gets deeper and reaches the limit of the water-based muds due to limitations such as lubricity and well bore stabilization. The majority of gels employ water compatible gelling and crosslinking agents, as exemplified by U.S. Patent Application Publication No. 20060011343 and U.S. Pat. Nos. 7,008,908 and 6,165,947, which are useful when using water-based muds. There is, however, a dearth of methods using non-aqueous gels which are compatible with oil-based muds.

Thus, there is a need for the development non-aqueous gels for downhole applications that are relatively environmentally safe, and compatible with oil-based muds.

### SUMMARY OF INVENTION

In one aspect, embodiments disclosed herein relate to a method of treating an earth formation that includes introducing at least one curable liquid elastomer composition in a liquid phase into the earthen formation; introducing at least one curing agent into the earthen formation; and contacting the curable elastomer composition and curing agent to form a non-aqueous gel.

In another aspect, embodiments disclosed herein relate to a method of making a non-aqueous gel that includes providing a mixture of at least one curable elastomer composition and at least one curing agent in a solvent; and reacting the curable elastomer composition and curing agent to form a non-aqueous gel.

Other aspects and advantages of the invention will be apparent from the following description and the appended claims.

### DETAILED DESCRIPTION

Embodiments disclosed herein relate to the use of non-aqueous gels in downhole applications. Other embodiments of the disclosure relate to methods for producing non-aqueous gels. In the following description, numerous details are set forth to provide an understanding of the present disclosure. However, it will be understood by those skilled in the art that the present invention may be practiced without these details and that numerous variations or modifications from the described embodiments may be possible.

In one aspect, embodiments disclosed herein relate to a process for treating an earth formation. The process may include: introducing a liquid elastomer composition into the earthen formation; introducing a curing agent into the earthen formation, and contacting the liquid elastomer and the curing agent to form a gel. In other aspects, embodiments disclosed herein relate to methods of making such gels, and applications in which the gels disclosed herein may be useful.

Non-Aqueous Gels

A gel is a colloidal system in which an extended porous network of interconnected molecules spans the volume of a liquid medium. Although gels appear to be solid, jelly-like materials, by weight, gels are mostly liquid. The non-aqueous gels of the present disclosure may be used in downhole applications as a component of drilling mud and may be preformed and pumped downhole. Alternatively, the components may be introduced simultaneously or sequentially downhole forming the gel in situ. For example, the liquid components may be pumped into a wellbore which traverses a loosely consolidated formation, and allowed to cure, thereby forming a polymeric network which stabilizes the formation and the wellbore as a whole.

In some embodiments, the gels are formed from a variety of liquid elastomer compositions cured or crosslinked to form the gelatinous structure. Further, accelerators or retardants may optionally be added to effect or enhance gel formation. Also, additives such as stabilizers, plasticizers, adhesion promoters, and fillers may be added to enhance or tailor the gel properties.

Curable Liquid Elastomers

Liquid elastomers are amorphous polymers that exist, at ambient conditions, well above their glass transition temperature (Tg). At ambient temperatures, these elastomers are liquids which may vary in viscosity from pourable liquids to medium or high viscosity liquids. These liquid elastomers may be cured or crosslinked to a higher molecular weight bulk material, such as the non-aqueous gel of the present disclosure, which may have desirable mechanical and chemical properties. Such properties may include hardness, durability, and resistance to chemicals.

In order for the liquid elastomers to be curable or crosslinked, they must contain two or more terminally reactive groups or reactive alkenyl bonds for crosslinking. While terminal hydroxyl groups may constitute one class of terminally reactive groups, other terminally reactive groups include mercapto, silanes, or carboxylic acid groups, etc. Thus, exemplary liquid elastomers which contain reactive end groups suitable for use in the present disclosure may include polysulfides, polyurethanes, polyethers, polysiloxanes, polybutadienes (as well as poly(butadiene-styrene) or poly(butadiene-acrylonitrile) copolymers), and polyisoprenes, modified derivatives versions, thereof, all of which contain two or more terminal hydroxyl, mercapto (or thiol), silane (or silanol), or carboxyl groups or reactive alkenyl bonds. Such terminated elastomers may be produced according to conventional processes and techniques well known to those skilled in the art.

Depending on the particular application, it may be desirable to form an elastomeric gel downhole to consolidate or otherwise treat loose or permeable formations. Liquid elastomers are particularly well suited for downhole applications because they are pumpable in their uncured state. In various embodiments, the liquid elastomer may be used in its neat form, may be dissolved in a solvent, or may be dispersed or emulsified in a non-miscible phase, and a curing agent may be added to the liquid elastomer to form a gel.

For example, such a liquid elastomer may be pumped downhole to traverse a loosely consolidated formation in the wellbore. A curing agent and desired additives may then be pumped downhole to cure the liquid elastomer to form a strongly bonded matrix that may efficiently coat the loosely consolidated formation. The inventors of the present disclosure have discovered that such a strongly bonded matrix may effectively retain the loosely consolidated formation, therefore controlling the production of sand grains from the treated zones. This treatment may serve to strengthen the wellbore and reduce debris which may cause wear to downhole tools. Alternatively, it may also be envisioned that the gel is preformed, and introduced into the wellbore.

As mentioned above, to be curable, an elastomer component may have silane groups as reactive terminal groups. Such silane groups may be included on a variety of elastomeric polymers; however, in particular embodiments, they may be provided on polysiloxanes, polyurethanes, polyethers, etc. For example, SPUR+® polymers, commercially available from GE, are isocyanate-free silane end-capped polyurethane prepolymers. In further embodiments, the curable liquid elastomer is a liquid polysulfide, whereby terminal mercapto group may facilitate curing of the elastomer. One example of such polysulfide polymers include THIOPLAST™ polymers, which are commercially available from Akzo Nobel. However, one skilled in the art that other terminal groups may be alternatively be used, and that there is no limitation on the type of reactive terminal groups that may be provided on the liquid elastomers suitable for use in the present disclosure. Additionally, while alkenyl bonds may also provide for curing, it is also within the scope of the present disclosure that elastomers such as polybutadiene or polyisoprene may optionally also be modified to include reactive groups such as hydroxyl or carboxyl terminal groups. Moreover, one skilled in the art would appreciate that while several types of liquid elastomers have been described here, other similar liquid elastomers may find use in forming the gels of the present disclosure.

In further embodiments, the liquid elastomer may be branched or dendritic. In yet other embodiments, combinations of any of the above listed materials to be cured may be used. Further, one of ordinary skill in the art would appreciate that other liquid elastomer compositions may be also used to form a gel in accordance with the embodiments of the present disclosure.

Curing Agents

The desired non-aqueous gel may be achieved by contacting a liquid elastomer with a curing agent. A curing agent changes the properties of the liquid elastomer, in this case, forming a colloidal system or gel. Curing can be achieved by the use of a crosslinking agent, a catalyst, or a combination thereof.

Catalysts

In some embodiments, the catalyst may include organometallic catalysts such as organic complexes of Sn, Ti, Pt, Pb, Sb, Zn, or Rh, inorganic oxides such as manganese (IV) oxide, calcium peroxide, or lead dioxide, and combinations thereof, metal oxide salts such as sodium perborates and other borate compounds, organic hydroperoxides such as cumene hydroperoxide, or sulfur (including sulfur based compounds). In a particular embodiment, the organometallic catalyst may be dibutyltin dilaurate, a titanate/zinc acetate material, tin octoate, a carboxylic salt of Pb, Zn, Zr, or Sb, and combinations thereof.

The catalyst may be present in an amount effective to catalyze the curing of the liquid elastomer composition. In various embodiments, the catalyst may be used in an amount ranging from about 0.01 to about 10 weight percent, based on the total weight of the liquid elastomer(s), from about 0.05 to about 5 weight percent in other embodiments, and from about 0.10 to about 2 weight percent in yet other embodiments.

Crosslinking Agents

In one embodiment, the liquid elastomer composition is contacted with at least one crosslinking agent in order to effect the formation of the non-aqueous gel. In general, the crosslinking agent may be any nucleophilic or electrophilic group that may react with the reactive groups available in the liquid elastomer. In a further embodiment, the crosslinking agent may comprise a polyfunctional molecule with more than one reactive group. Such reactive groups may include for example, amines, alcohols, phenols, thiols, carbanions, organofunctional silanes, and carboxylates.

In one embodiment, the crosslinking agent may be an aliphatic polyamine such as ethylenediamine (EDA), diethylenetriame (DTA), and triethylenetetramine (TETA), which comprise a short, linear chain between amine groups. Crosslinking with such agents tends to create highly crosslinked layers with good resistance to heat and chemicals, including solvents. In another embodiment, the aliphatic amine may be a polyethylenimine (PEI), which are ethylenediamine polymers and are commercially available under the trade name Lupasol® from BASF (Germany). PEIs may vary in degree of branching and therefore may vary in degree of crosslinking. Lupasol® PEIs may be small molecular weight constructs such as Lupasol® FG with an average molecular weight of 800 or large molecular weight constructs such as Lupasol® SK with average molecular weight of 2,000,000.

In yet another embodiment the aliphatic amine may be a polyetheramine such as those commercially available under the trade name Jeffamine® Huntsman Performance Products (Woodlands, Tex.). For example, useful Jeffamine® products may include triamines Jeffamine® T-5000 and Jeffamine® T-3000 or diamines such as as Jeffamine® D-400 and Jeffamine® D-2000. Useful polyetheramines may possess a repeating polyether backbone and may vary in molecular weight from about 200 to about 5000 g/mol. Crosslinking with these constructs may lead to products with excellent flexibility and impact resistance.

In one embodiment, the crosslinking agent may include modified cycloaliphatic amines derived from 3-aminomethyl-3,5,5-trimethyl cyclohexyl amine (IPDA). They produce crosslinked products with a fast cure rate, and are suitable for low temperature operations. Crosslinked products comprising IPDA derivatives provide very good resistance to chemicals, common solvents and water.

In one embodiment, the crosslinking agent may be an aromatic amine. The amine groups are separated by rigid benzene rings rather than flexible chains of molecules as in the aliphatic amines. Polymers produced with aromatic amines may possess good physical properties like impact resistance as well as high resistance to heat and chemicals, particularly when they are formulated with epoxy novolac-type resins. Such crosslinked products may also exhibit high temperature resistance and may possess good water resistance. Aromatic amines may comprise such commercial products as the phenalkamines available from Cardolite Corporation (Newark, N.J.) and may include Lite-2002, NC-558, NC-540, NC-541, NC-546, NC-549 and NC-550.

In some embodiments, the crosslinking agent may include an organofunctional silane that may be represented as R—Si—X₃ or Si—X₄, where the R group is an organic group such as a methyl, ethyl, or vinyl and the X group is a moisture hydrolysable group, such as an acetoxy, an alkoxy, an oxime, an acetone, hydroxysilyl, or a benzamide group. In further embodiments, the crosslinking agent may be CH₃Si(OC(O)CH₃)₃, CH₃Si(OCH₃)₃, CH₃Si(ONC(CH₃)C₂H₅)₃, CH₃Si(OC(CH₂)CH₃)₃, or CH₃Si(N(CH₃)C(O)C₆H₅)₃. Further, one skilled in the art would appreciate that siloxane may alternatively be used.

The crosslinking agent may be present in an amount effective to crosslink the liquid elastomer. In some embodiments, the crosslinking agent may be used in an amount ranging from about 0.05 to about 50 weight percent based on the total weight of the liquid elastomer(s), from about 5 to about 40 weight percent in other embodiments, and from about 10 to about 35 weight percent in yet other embodiments. In other embodiments, a weight ratio of the crosslinking agent to the liquid elastomer may be from 1:2000 to 1:1; from 1:20 to 1:2 in other embodiments, and from 1:10 to about 1:3 in yet other embodiments.

The amount of crosslinking agent may affect the hardness of the resulting gel. For example, in some embodiments, for a constant weight of liquid elastomer, increasing the amount of crosslinking agent may result in a higher crosslinking density, and therefore a harder gel.

Using the guidelines provided herein, those skilled in the art will be capable of determining a suitable amount of cross-linking agent to employ to achieve a gel of the desired hardness.

Accelerators and Retardants

Accelerators and retardants may optionally be used to control the cure time of the liquid elastomer. For example, an accelerator may be used to shorten the cure time while a retardant may be used to prolong the cure time. In some embodiments, the accelerator may include an amine, a sulfonamide, or a disulfide, and the retardant may include a stearate, an organic carbamate and salts thereof, a lactone, or a stearic acid.

Additives

Additives are widely used in elastomer compositions to tailor the physical properties of the resultant polymeric gel. In some embodiments, additives may include plasticizers, thermal and light stabilizers, flame-retardants, fillers, adhesion promoters, or rheological additives.

Addition of plasticizers may reduce the modulus of the polymer at the use temperature by lowering its Tg. This may allow control of the viscosity and mechanical properties of the non-aqueous gel. In some embodiments, the plasticizer may include phthalates, epoxides, aliphatic diesters, phosphates, sulfonamides, glycols, polyethers, trimellitates or chlorinated paraffin. In some embodiments, the plasticizer may be a diisooctyl phthalate, epoxidized soybean oil, di-2-ethylhexyl adipate, tricresyl phosphate, or trioctyl trimellitate.

Fillers are usually inert materials which may reinforce the non-aqueous gel or serve as an extender. Fillers therefore affect gel processing, storage, and curing. Fillers may also affect the properties of the gel such as electrical and heat insulting properties, modulus, tensile or tear strength, abrasion resistance and fatigue strength. In some embodiments, the fillers may include carbonates, metal oxides, clays, silicas, mica, metal sulfates, metal chromates, or carbon black. In some embodiments, the filler may include titanium dioxide, calcium carbonate, non-acidic clays, or fumed silica.

Addition of adhesion promoters may improve adhesion to various substrates. In some embodiments, adhesion promoters may include epoxy resins, modified phenolic resins, modified hydrocarbon resins, polysiloxanes, silanes, or primers.

Addition of rheological additives may control the flow behavior of the compound. In some embodiments, rheological additives may include fine particle size fillers, organic agents, or combinations of both. In some embodiments, rheological additives may include precipitated calcium carbonates, non-acidic clays, fumed silicas, or modified castor oils.

Gel Preparation

In one embodiment, the gel is formed by mixing the elastomer with the curing agent and additives in an appropriate solvent. Solvents that may be appropriate may comprise oil-based muds for use in downhole applications and may include mineral oil, biological oil, diesel oil, and synthetic oils.

Curing Mechanisms

One of ordinary skill in the art would appreciate that the curing mechanism for the liquid elastomer compositions may depend on the chemical composition of the particular component elastomer. Some exemplary curing mechanisms are shown below for polysiloxane, liquid polysulfides, silylated polyurethane prepolymers, and polyisoprenes.

Polysiloxanes

Polysiloxanes may be formed through a moisture cure. A siloxane polymer has terminal silanol (SiOH) groups which may readily react via a condensation reaction to produce longer chains. Particularly, the silanol-terminated polymer may first react with a crosslinker, such as those described above, via a condensation reaction as shown below in Eq. 1:

HOSiMe₂O(Me₂SiO)ₙSiMe₂OH+2RSiX₃→X₂(R)SiO(Me₂SiO)ₙ₊₁SiRX₂+2HX (1)

The crosslinker-terminated polymer may then be hydrolyzed by moisture to form terminal silanol groups on the growing polymer chain as shown below in Eq. 2:

X₂(R)SiO(Me₂SiO)ₙ₊₁SiRX₂+H₂→HOXRSiO(Me₂SiO)ₙ₊₁SiRX2+HX (2)

These reactive silanol chains may then react with another polymer to exponentially extend the growing polysiloxane network as shown below in Eq. 3:

X₂RSiO(Me₂SiO)nSiRX₂+HOXRSiO(Me₂SiO)ₙ₊₁SiRX₂→

X₂RSiO(Me₂SiO)ₙSiRX—OXRSiO(Me₂SiO)ₙ₊₁SiRX₂+HX (3)

Further, repeated hydrolysis and reaction of reactive polymer ends may eventually lead to full cure.

Liquid Polysulfides

A polysulfide includes reactive thiol terminal groups that may enable cure via oxidation or addition mechanisms. The oxidation mechanism, which is more popular, is the basis of many commercial polysulfide cure formulation and is shown below in Eq. 4:

2˜R—SH+[O]→˜R—S—S—R˜+H2O (4)

where [O] represents an oxidizing agent. Reactions with oxidizing agents may produce disulfide linkages and thus longer chains. Curing agents suitable for use in oxidative cure of a polysulfide may include oxidizing agents such as inorganic oxides, peroxides, metal oxide salts or organic hydroperoxides.

Silylated Polyurethanes

Silane terminated polyurethanes are low viscosity prepolymers which may undergo a moisture cure. The alkyl or alkoxy groups on the terminal silanes, which are methyl groups in the exemplary mechanism shown below, may be readily cleaved by moisture to silanol groups. These prepolymers having reactive silanol groups may form larger chains by condensation reaction and the loss of a byproduct of an alcohol or acetic acid as shown below in Eq. 5:

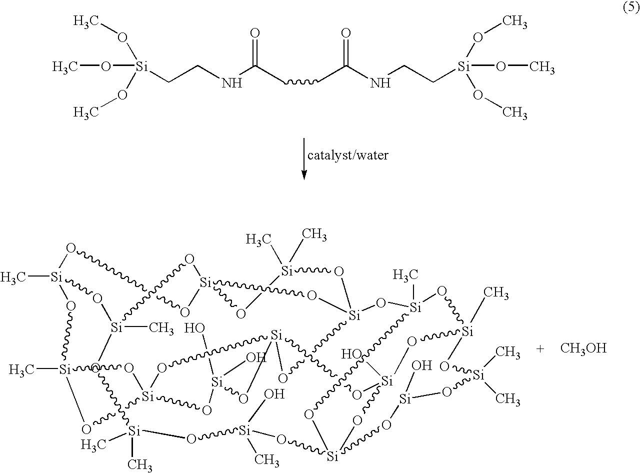

Polyisoprene/Polybutadiene

Polybutadienes and polyisoprenes may be found as liquid elastomers at low molecular weights. Such liquid polybutadienes/polyisoprenes may be cured by catalysts or uncatalyzed at higher temperatures. Further, they may cure via crosslinking at alkenyl bonds present due to the diene monomer as shown below in Eq. 6 for polyisoprene crosslinked with sulfer:

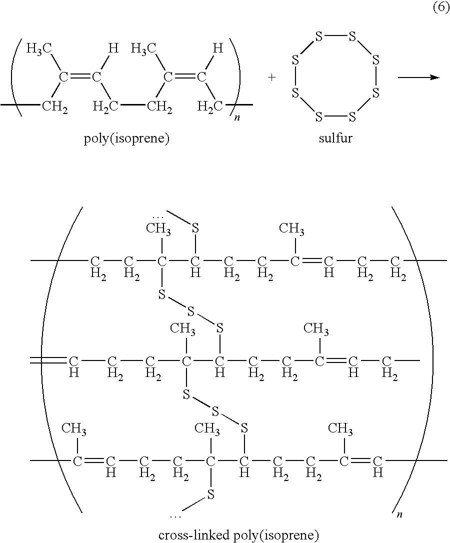

Alternatively, one skilled in the art would appreciate that polybutadiene or polyisoprene adducts may be used to incorporate a hydroxyl or carboxy terminal group for example, to facilitate crosslinking. Further, in addition to sulfur, one skilled in the art would appreciate that other crosslinkants such as peroxide-based crosslinkants may be used to cure polybutadiene or polyisoprene.

In various embodiments, the cure mechanisms may be temperature dependent. Thus, some elastomers may preferentially cure at elevated temperatures, while yet others may cure at room temperatures.

Aging Temperature

In some embodiments, the liquid elastomer and the curing agent may be reacted at a temperature from −50 to 300° C. In other embodiments, the liquid elastomer and the curing agent may be reacted at a temperature from 25 to 250° C.; from 50 to 150° C. in other embodiments; and from 60 to 100° C. in yet other embodiments. However, one of ordinary skill in the art would appreciate that, in various embodiments, the reaction temperature may determine the amount of time required for gel formation.

Time Required for Gel Formation

Embodiments of the gels disclosed herein may be formed by mixing a liquid elastomer with a catalyst, a crosslinking agent, or a mixture of a catalyst and a crosslinking agent. In some embodiments, a gel may form immediately upon mixing the liquid elastomer and the curing agent. In other embodiments, a gel may form within 1 minute of mixing; within 5 minutes of mixing in other embodiments; within 30 minutes of mixing in other embodiments. In some embodiments, a gel may form within 1 hour of mixing; within 8 hours in other embodiments; within 16 hours in other embodiments; within 80 hours in other embodiments; within 120 hours in yet other embodiments.

Gel Viscosity

In some embodiments, a solution of liquid elastomer(s) and curing agent(s) in water may initially have a viscosity similar to that of water. A water-like viscosity may allow the solution to effectively penetrate voids, small pores, and crevices, such as encountered in fine sands, coarse silts, and other formations. In other embodiments, the viscosity may be varied to obtain a desired degree of flow sufficient for decreasing the flow of water through or increasing the load-bearing capacity of a formation. The viscosity of the solution may be varied by increasing or decreasing the amount of water relative to the curing agent and liquid elastomers, by employing viscosifying agents, or by other techniques common in the art.

In some embodiments, the combined amount of liquid elastomer(s) and curing agent(s) may range from 0.5 to 100 weight percent, based upon the total weight of water in the solution. In other embodiments, the combined amount of liquid elastomer(s) and curing agent(s) may range from 5 to 100 weight percent, based upon the total weight of water in the solution; from 20 to 70 weight percent in other embodiments; from 25 to 65 weight percent in yet other embodiments. As used herein, total weight of water is exclusive of any additional water added with pH adjusting reagents.

Gel Hardness

The reaction of the liquid elastomer(s) and curing agent(s) may produce gels having a consistency ranging from a viscous sludge to a hard gel. In some embodiments, the reaction of the liquid elastomer(s) and curing agent(s) may result in a soft elastic gel. In other embodiments, the reaction may result in a firm gel and in a hard gel in yet other embodiments. The hardness of the gel is the force necessary to break the gel structure, which may be quantified by measuring the force required for a needle to penetrate the crosslinked structure. Hardness is a measure of the ability of the gel to resist to an established degree the penetration of a weighted test needle.

Hardness may be measured by using a Brookfield QTS-25 Texture Analysis

Instrument. This instrument consists of a probe of changeable design that is connected to a load cell. The probe may be driven into a test sample at specific speeds or loads to measure the following parameters or properties of a sample: springiness, adhesiveness, curing, breaking strength, fracturability, peel strength, hardness, cohesiveness, relaxation, recovery, tensile strength burst point, and spreadability. The hardness may be measured by driving a 4 mm diameter, cylindrical, flat faced probe into the gel sample at a constant speed of 30 mm per minute. When the probe is in contact with the gel, a force is applied to the probe due to the resistance of the gel structure until it fails, which is recorded via the load cell and computer software. As the probe travels through the sample, the force on the probe and the depth of penetration are measured. The force on the probe may be recorded at various depths of penetration, such as 20, 25, and 30 mm, providing an indication of the gel's overall hardness.

In some embodiments, the resulting gel may have a hardness value from 10 to 100000 gram-force. In other embodiments, the resulting gel may be a soft elastic gel having a hardness value in the range from 10 to 100 gram-force. In other embodiments, the resulting gel may be a firm gel having a hardness value from 100 to 500 gram-force. In other embodiments, the resulting gel may range from hard to tough, having a hardness value from 500 to 100000 gram-force; from 1500 to 75000 gram-force in other embodiments; from 2500 to 50000 gram-force in yet other embodiments; from 5000 to 30000 gram-force in yet other embodiments.

In other embodiments, the hardness of the gel may vary with the depth of penetration. For example, the gel may have a hardness of 1500 gram-force or greater at a penetration depth of 20 mm in some embodiments. In other embodiments, the gel may have a hardness of 5000 gram-force or greater at a penetration depth of 20 mm; 15,000 gram-force or greater at a penetration depth of 20 mm in other embodiments; and 25000 gram-force or greater at a penetration depth of 25 mm in yet other embodiments.

With respect to the variables listed above (i.e. temperature, time, etc.), those having ordinary skill in light of the disclosure will appreciate that, by using the present disclosure as a guide, properties may be tailored as desired.

Elastomer Processing

Some embodiments of the non-aqueous gels disclosed herein may be formed in a single component system, where the curing agent(s), additives, accelerators or retarders are premixed with the liquid elastomer(s) (material to be crosslinked). The gel may then be placed or injected prior to cure. The gel times may be adjusted by the use of retarders or accelerators. Other embodiments of the gels disclosed herein may also be formed in a two-component system, where the curing agent(s) and liquid elastomer(s) may be mixed separately and combined immediately prior to injection. Alternatively, one reagent, the curing agent or liquid elastomer, may be placed in the wellbore or the near-wellbore region where it may then be contacted by the other reagent, either the curing agent or liquid elastomer as required.

### EXAMPLES

### Example 1

Samples of the SPUR® 1050 mm prepolymers were mixed in various proportions and the following additives were optionally added: water, base oil, VG-SUPREME™ (VGS) (organophilic clay), M-I SWACO EMI 79 (an oil-soluble polymeric surfactant), Momentum Performance Chemicals VX225 (an amino-functionalised adhesion promoter), M-I SWACO STARCARB (fine grade calcium carbonate), Degussa Aero R974 (hydrophobic fumed silica), and Viaton AW2 (very fine grade barite). The samples were cured at 70° C. for either 16 and/or 24 hours. The hardness of the resultant gels was then measured after the samples had cooled. The initial hardness is the peak force on the probe just before the gel fails or tears. The bulk low and high values are the lowest and highest values after the initial peak as the probe travels through the bulk of the sample. Gels that are so elastic that the gel does not tear or fail before the end of the test (when the probe hits the bottom of the test vial), renders a “no failure” (NF) reading. The formulations and hardness results are shown below in Tables 1(a) and 1(b).

The samples presented in Table 1(a) were initially cured for 16 hrs at 70° C., after this period it was noted that all the samples were still liquid. As a consequence 0.1 mL Dow Corning® Catalyst 62 was added to each sample, and the samples were then cured for an additional 24 hrs at 70° C. After 24 hrs it was observed that the catalyst had caused the samples to form an elastomeric gel material, demonstrating that the reaction can be controlled with the use of various chemical additives. The data presented in Table 1(b) is presented to show that the gel properties can be altered by varying the formulation.

TABLE 1(a)

| Sample # | | | | | | | | | | |
|---|---|---|---|---|---|---|---|---|---|---|
| 1 | 2 | 3 | 4 | 5 | 6 | 7 | 8 | 9 | 10 | 11 |

Volume (mL)

| | | | | | | | | | | | |
|---|---|---|---|---|---|---|---|---|---|---|---|
| SPUR ® | 20 | 20 | 20 | 10 | 10 | 10 | 1 | 2 | 4 | 2 | 4 |
| 1050 mm | | | | | | | | | | | |
| Water | — | 0.1 | 1 | 0.1 | 1 | — | 0.1 | 0.1 | 0.1 | 0.1 | 0.1 |
| Base Oil | — | — | — | 10 | 10 | 10 | 10 | 10 | 10 | 10 | 10 |
| VGS | — | — | — | — | — | 0.2 | — | — | — | 0.2 | 0.2 |
| EMI 759 | — | — | — | — | — | — | — | — | — | 0.5 | 0.2 |

Hardness at 24 hrs (gForce)

| | | | | | | | | | | | |
|---|---|---|---|---|---|---|---|---|---|---|---|
| Initial | 2160 | 5030 | 4630 | 1111 | 1379 | 1768 | 100 | 1000 | 1150 | 1000 | 666 |
| Bulk | 437 | NF | 3944 | 921 | 951 | 983 | NF | NF | 407 | — | 375 |
| Low | | (22 s) | | | | | | | | | |
| Bulk | 2000 | NF | NF | 1271 | 1284 | 1708 | — | — | 779 | — | 601 |
| High | | (22 s) | (28 s) | | | | | | | | |

TABLE 1(b)

| Sample # | | | | | | | | | |
|---|---|---|---|---|---|---|---|---|---|
| 12 | 13 | 14 | 15 | 16 | 17 | 18 | 19 | 20 | 21 |

Volume (mL)

| | | | | | | | | | | |
|---|---|---|---|---|---|---|---|---|---|---|
| SPUR ® | 4 | 4 | 4 | 4 | 4 | 4 | 1 | 2 | 4 | 2 |
| 1050 mm | | | | | | | | | | |
| Base Oil | 10 | 10 | 10 | 10 | 10 | 10 | 10 | 10 | 10 | 10 |
| VGS | 0.2 | 0.2 | 0.2 | 0.2 | 0.2 | 0.2 | — | — | — | — |
| VX225 | — | 0.2 | 0.2 | 0.2 | 0.2 | 0.2 | — | 0.2 | 0.2 | 0.2 |
| AW2 | — | — | 2.5 | — | 5 | — | — | — | 2.5 | — |
| STARCARB | — | — | — | 5 | — | 10 | — | — | — | 0.5 |
| Aero R974 | — | — | — | — | — | — | 0.2 | 0.2 | 0.2 | 0.2 |

Hardness at 24 hours (g Force)

| | | | | | | | | | | |
|---|---|---|---|---|---|---|---|---|---|---|
| Initial | 565 | 818 | 1120 | 1986 | 1043 | 1152 | 972 | 3250 | 2793 | 2209 |
| Bulk Low | 182 | 443 | 590 | 660 | 745 | 886 | 586 | 1200 | 1308 | 1329 |
| Bulk High | 335 | 663 | 1016 | 1167 | 1156 | 1500 | 953 | 1200 | 1597 | 1829 |

### Example 2

Samples of THIOPLAST™ G polymers (polysulfides) from Akzo Nobel Functional Chemicals GmbH & Co. KG (Greiz, Germany) were mixed in various proportions and the following additives were optionally added: base oil (DF1), VG-SUPREME™ (VGS) (organophilic clay), M-I SWACO EMI 759 (an oil-soluble polymeric surfactant), and magnesium peroxide for crosslinking. The THIOPLAST™ G polymers were not soluble in the DF 1 base oil, so stepwise additions of VGS and EMI 759 were made until stable suspensions were formed. Polyisoprene (40,000 Mw) and block polybutadiene polyisoprene (30,000 to 50,000 Mw) samples were obtained from Sigma-Aldrich. The samples were cured at 70° C. for 48 hours after which a further 0.5 g of MgO₂ and water was added to each sample before curing for an additional 24 hours, the results of which are shown in Table 2(a) below.

TABLE 2(a)

| | | | | | | Hardness 24 h after | | |
|---|---|---|---|---|---|---|---|---|
| | | | | | | further addition | | |
| | | DF1 | VGS | MgO₂ | EMI 759 | | Bulk | Bulk |
| Elastomer (ml) | | (ml) | (g) | (g) | (ml) | Initial | Low | High |
| THIOPLAST ™ | 20 | — | — | 0.5 | — | 1372 | NF | — |
| G1 | | | | | | | | |
| THIOPLAST ™ | 20 | — | — | 0.5 | — | low vis | — | — |
| G4 | | | | | | liquid | | |
| THIOPLAST ™ | 20 | — | — | 0.5 | — | Visc liquid | — | — |
| G21 | | | | | | | | |
| THIOPLAST ™ | 10 | 10 | 0.6 | 0.5 | 3 | Paste | — | — |
| G1 | | | | | | | | |
| THIOPLAST ™ | 10 | 10 | 0.2 | 0.5 | 2 | Sep low | — | — |
| G4 | | | | | | visc liquid | | |
| THIOPLAST ™ | 10 | 10 | 0.5 | 0.5 | 3 | Paste | — | — |
| G21 | | | | | | | | |
| Polyisoprene | 10 | — | — | 0.5 | — | visc liquid | — | — |
| Polyisoprene | 10 | 10 | — | 0.5 | — | low visc | — | — |
| | | | | | | liquid | | |
| Polyisoprene/ | 10 | — | — | 0.5 | — | Visc gel | — | — |
| butadiene | | | | | | | | |
| Polyisoprene/ | 10 | 10 | — | 0.5 | — | Visc liquid | — | — |
| butadiene | | | | | | | | |

The tests were repeated with using greater amounts of MgO₂ and water. The results of these tests are shown in Table 2(b) below.

TABLE 2(b)

| | | | | | | | Hardness after 16 hrs @ 70° C. | | |
|---|---|---|---|---|---|---|---|---|---|
| | | DF1 | VGS | MgO₂ | EMI 759 | Water | | | Bulk |
| Elastomer (ml) | | (ml) | (g) | (g) | (ml) | (ml) | Initial | Bulk Low | High |
| THIOPLAST ™ | 15 | — | — | 3 | — | 1 | 2920 | 2500 | 3890 |
| G1 | | | | | | | | | |
| THIOPLAST ™ | 15 | — | — | 3 | — | 1 | Visc | — | — |
| G4 | | | | | | | liquid | | |
| THIOPLAST ™ | 15 | — | — | 3 | — | 1 | 1250 | Not | — |
| G21 | | | | | | | | homogenous | |
| THIOPLAST ™ | 10 | 10 | 0.8 | 2 | 3 | 1 | Paste | — | — |
| G1 | | | | | | | | | |
| THIOPLAST ™ | 10 | 10 | 0.6 | 2 | 3 | 1 | Paste | — | — |
| G4 | | | | | | | | | |
| THIOPLAST ™ | 10 | 10 | 0.6 | 2 | 3 | 1 | Paste | — | — |
| G21 | | | | | | | | | |
| Polyisoprene | 15 | — | — | 3 | — | 1 | stiff | — | — |
| | | | | | | | liquid/gel | | |
| Polyisoprene | 10 | 10 | — | 2 | — | 1 | stiff | — | — |
| | | | | | | | liquid/gel | | |
| Polyisoprene/ | 15 | — | — | 3 | — | 1 | stiff | — | — |
| butadiene | | | | | | | liquid/gel | | |
| Polyisoprene/ | 10 | 10 | — | 2 | — | 1 | stiff | — | — |
| butadiene | | | | | | | liquid/gel | | |

Applications

Some embodiments of the gels disclosed herein may be formed in a one-solution single component system, where the curing/crosslinking agent(s) are premixed with the liquid curable elastomers, and the mixture may then be placed or injected prior to cure. The gel times may be adjusted by changing the quantity of water (or other solvent) in the solution. Other embodiments of the gels disclosed herein may also be formed in a two-component system, where the curing/crosslinking agents and liquid elastomers may be mixed separately and combined immediately prior to injection. Alternatively, one reagent, the liquid elastomer or curing/crosslinking agent, may be placed in the wellbore or the near-wellbore region where it may then be contacted by the other reagent, either the liquid elastomer or curing/crosslinking agent as required.

Embodiments of the gels disclosed herein may be used in applications including: as an additive in drilling muds; as an additive for enhancing oil recovery (EOR); as one additive in loss circulation material (LCM) pills; wellbore (WB) strengthening treatments; soil stabilization; as a dust suppressant; as a water retainer or a soil conditioner; as hydrotreating (HT) fluid loss additives, and others.

Use in Drilling Muds

Drilling fluids or muds typically include a base fluid (for example water, diesel or mineral oil, or a synthetic compound), weighting agents (for example, barium sulfate or barite may be used), bentonite clay, and various additives that serve specific functions, such as polymers, corrosion inhibitors, emulsifiers, and lubricants. Those having ordinary skill in the art will recognize that a number of different muds exist, and limitations on the present invention is not intended by reference to particular types. During drilling, the mud is injected through the center of the drill string to the drill bit and exits in the annulus between the drill string and the wellbore, fulfilling, in this manner, the cooling and lubrication of the bit, casing of the well, and transporting the drill cuttings to the surface.

The gels disclosed herein may be used as an additive in drilling mud. In some embodiments, the gels may form a filter cake or one component of a filter cake that forms along the wellbore as drilling progresses. The gels contained in the drilling fluid may be deposited along the wellbore throughout the drilling process, potentially strengthening the wellbore by stabilizing shale formations and other sections encountered while drilling. Improved wellbore stability may reduce the occurrence of stuck pipe, hole collapse, hole enlargement, lost circulation, and may improve well control.

Wellbore stability may also be enhanced by the injection of a low viscosity mixture of a liquid elastomer and a curing agent into formations along the wellbore. The mixture may then continue to react, strengthening the formation along the wellbore upon gellation of the mixture.

In other embodiments, the gels disclosed herein may aid in lifting solid debris from tubing walls and through the tubing annulus. Hard gels circulating through the drill pipe during drilling may scrape and clean the drill pipe, removing any pipe scale, mud, clay, or other agglomerations that may have adhered to the drill pipe or drill tubing. In this manner, the drill pipe may be maintained free of obstructions that could otherwise hinder removal of drilled solids from the drill pipe during drilling.

Enhanced Oil Recovery

Embodiments of the gels disclosed herein may be used to enhance secondary oil recovery efforts. In secondary oil recovery, it is common to use an injection well to inject a treatment fluid, such as water or brine, downhole into an oil-producing formation to force oil toward a production well. Thief zones and other permeable strata may allow a high percentage of the injected fluid to pass through only a small percentage of the volume of the reservoir, for example, and may thus require an excessive amount of treatment fluid to displace a high percentage of crude oil from a reservoir.

To combat the thief zones or high permeability zones of a formation, embodiments of the gels disclosed herein may be injected into the formation. Gels injected into the formation may partially or wholly restrict flow through the highly conductive zones. In this manner, the gels may effectively reduce channeling routes through the formation, forcing the treating fluid through less porous zones, and potentially decreasing the quantity of treating fluid required and increasing the oil recovery from the reservoir.

In other embodiments, gels may also be formed in situ within the formation to combat the thief zones. Liquid elastomer components may be injected into the formation, allowing the elastomer components to penetrate further into the formation than if a gel was injected. The curing/crosslinking agents may then be injected, causing the previously injected liquid elastomer components to cure/crosslinking within the formation. By forming the gels in situ in the formation, it may be possible to avert channeling that may have otherwise occurred further into the formation, such as where the treatment fluid traverses back to the thief zone soon after bypassing the injected gels as described above.

LCM Pills

As mentioned above, gels disclosed herein may be used as one component in a drilling fluid. The gels may form part of a filter cake, minimizing seepage of drilling fluids to underground formations and lining the wellbore. As another example, embodiments of the gels disclosed herein may be used as one component in loss circulation material (LCM) pills that are used when excessive seepage or circulation loss problems are encountered, requiring a higher concentration of loss circulation additives. LCM pills are used to prevent or decrease loss of drilling fluids to porous underground formations encountered while drilling.

In some embodiments, the liquid elastomer or curing/crosslinking agent may be mixed prior to injection of the pill into the drilled formation. The mixture may be injected while maintaining a low viscosity, prior to gel formation, such that the gel may be formed downhole. In other embodiments, the liquid elastomer or curing/crosslinking agent may be injected into the formation in separate shots, mixing and reacting to form a gel in situ (in the formation following injection of the LCM pill shots). In this manner, premature gel formation may be avoided.

For example, a first mixture containing a liquid elastomer may be injected into the wellbore and into the lost circulation zone. A second mixture containing a curing/crosslinking agent may be injected, causing the gelling agent to cure/crosslink in situ to the point that the gel expands in size. The expanded and hardened gel may plug fissures and thief zones, closing off the lost circulation zone.

Gels disclosed herein may be used in other processes, including the aforementioned applications such as water retainers, soil conditioners, and hydrotreating (HT) fluid loss additives. It is further contemplated that gels described herein may be useful in other processes and applications known to those skilled in the art.

Advantages of the current disclosure may include a non-aqueous gel with excellent ability to vary the gel properties based on a variety of applications. Liquid elastomers display an exceptionally wide range of chemistries and physical properties. As such, the liquid elastomer may be selected to tailor the properties of the resultant non-aqueous gel. Adjustable gellation times, temperatures, and physical properties of the resulting gel may be selected for a particular desired application. For example, the non-aqueous gel may be chosen to an appropriate hardness, or flexural or elastic moduli. Additionally, liquid elastomer-based systems tend to be flexible, impact resistant, exhibit exceptional bond strength and low toxicity and volatility.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A method of treating an earth formation comprising:
introducing at least one curable liquid elastomer composition in a liquid phase into the earthen formation;
introducing at least one curing agent into the earthen formation; and
contacting the curable elastomer composition and curing agent to form a non-aqueous gel.

2. The method of claim 1, wherein the liquid phase comprises at least one curable liquid elastomer selected from a group comprising polysulfides, polyurethanes, polyethers, polysiloxanes, polybutadienes, polyisoprenes, modified derivatives thereof and copolymers.

3. The method of claim 1, wherein the liquid elastomer comprises at least one of a neat liquid elastomer, a liquid elastomer dissolved in a solvent, and a liquid elastomer emulsified or dispersed in a non-miscible fluid phase.

4. The method of claim 1, wherein the liquid phase further comprises at least one of a biological oil, a synthetic oil and a mineral oil.

5. The method of claim 1, wherein the curing agent comprises a moisture source.

6. The method of claim 5, where the moisture source is water.

7. The method of claim 5, wherein the curing agent comprises at least one of an organometallic catalyst, an inorganic oxide, an inorganic peroxide, a metal oxide salt, an organic hydroperoxide, sulfur, and mixtures thereof.

8. The method of claim 5, wherein the organometallic catalyst is at least one of an organic complex of Sn, Ti, Pt, Zn, and Rh.

9. The method of claim 5, wherein the curing agent further comprises a crosslinking agent represented by at least one of R—Si—X3 or Si—X4, where R represents alkyl, aryl, or vinyl organic groups, and X represents a moisture hydrolysable group.

10. The method of claim 5, wherein the curing agent further comprises an additive.

11. The method of claim 1, wherein the curable elastomer composition and the curing agent are injected simultaneously.

12. The method of claim 1, wherein the curable elastomer composition and the curing agent are injected sequentially.

13. The method of claim 1, wherein the treatment is at least one selected from wellbore strengthening, LCM treatments, water shutoff treatments, and zonal isolation treatments.

14. A method of making a non-aqueous gel comprising:
providing a mixture of at least one curable elastomer composition and at least one curing agent in a solvent; and
reacting the curable elastomer composition and curing agent to form a non-aqueous gel.

15. The method of claim 14, wherein the liquid phase comprises at least one curable liquid elastomer selected from a group comprising polysulfides, polyurethanes, polyethers, polysiloxanes, polybutadienes, polyisoprenes, modified derivatives thereof, and copolymers thereof.

16. The method of claim 14, wherein the liquid elastomer comprises at least one of a neat liquid elastomer, a liquid elastomer dissolved in a solvent, and a liquid elastomer emulsified or dispersed in a non-miscible fluid phase.

17. The method of claim 14, wherein the liquid phase further comprises at least one of a biological oil, a synthetic oil and a mineral oil.

18. The method of claim 14, wherein the curing agent comprises a moisture source.

19. The method of claim 14, where the moisture source is water.

20. The method of claim 14, wherein the curing agent comprises at least one of an organometallic catalyst, an inorganic oxide, an inorganic peroxide, a metal oxide salt, an organic hydroperoxide, sulfur, and mixtures thereof.

21. The method of claim 14, wherein the organometallic catalyst is at least one of an organic complex of Sn, Ti, Pt, Zn, and Rh.

22. The method of claim 14, wherein the curing agent further comprises a crosslinking agent represented by at least one of R—Si—X3 or Si—X4, where R represents alkyl, aryl, or vinyl organic groups, and X represents a moisture hydrolysable group.

23. The method of claim 14, wherein the curing agent further comprises an additive.

24. The method of claim 14, wherein the curable elastomer composition and the curing agent are injected simultaneously.

25. The method of claim 14, wherein the curable elastomer composition and the curing agent are injected sequentially.

26. The method of claim 14, wherein the treatment is at least one selected from wellbore strengthening, LCM treatments, water shutoff treatments, and zonal isolation treatments.

27. The method of claim 14, wherein the non-aqueous gel is formed downhole.
